(19) United States
(12) Patent Application Publication
(10) Pub. No.: US 2026/0202199 A1
(43) Pub. Date: Jul. 16, 2026

(54) CONTROL UNIT, SURVEYING INSTRUMENT, AND METHOD OF CONTROL THEREOF FOR IMPROVED MECHANICAL STABILITY

(71) Applicant: Trimble Inc., Westminster, CO (US)

(72) Inventors: Björn Johansson, Danderyd (SE); Staffan Molinder, Danderyd (SE)

(73) Assignee: Trimble Inc., Westminster, CO (US)

(21) Appl. No.: 19/563,815

(22) Filed: Mar. 11, 2026

Related U.S. Application Data
(63) Continuation of application No. PCT/EP2023/084941, filed on Dec. 8, 2023.

(51) Int. Cl. G01C 15/00; G01B 11/26; G01C 19/02; G05D 3/12

(52) U.S. Cl. CPC G01C 15/002; G01B 11/26; G01C 19/02; G05D 3/125

(57) ABSTRACT

There is provided a control unit for a surveying instrument having a base mounted on a support structure and a main body rotatable in relation to said base. The control unit is configured to produce a fused angle signal representative of an angular position of said main body relative to an external reference, and to provide a control signal for rotating said main body. The control unit further comprises: a resonance frequency finder configured to estimate at least one resonance frequency associated with said support structure, and a filter component configured to selectively apply at least one filter on said control signal, said fused angle signal, or said first angle signal, wherein an applied filter is configured to filter out a corresponding respective resonance frequency estimated by said resonance frequency finder. There is also provided a surveying instrument comprising such a control unit, and a method for controlling a surveying instrument.

### CROSS-REFERENCE TO RELATED APPLICATIONS

The present application is a continuation of International Application No. PCT/EP 2023/084941, filed Dec. 8, 2023, the entire contents of which are incorporated herein by reference in their entirety for all purposes.

### TECHNICAL FIELD

The present inventive concept relates to a control unit for a surveying instrument, a surveying instrument, and a method for controlling a surveying instrument. The control unit and method provide improved mechanical stability to the surveying instrument.

### BACKGROUND

Total stations are electronic instruments used for surveying, enabling angle and distance measurement between the total station and a point of measurement.

Typically, an alidade is rotatably arranged on a base, for rotation around a vertical axis. The base is mounted on a support structure, such as a tripod, a pillar, or a beam. A telescope is rotatably mounted on the alidade, for rotation about a horizontal axis. The telescope is aimed at the point of measurement by controlling its azimuthal and elevational orientation, i.e. by controlling the angular position of the alidade about the vertical axis and that of the telescope about the horizontal axis. This is achieved by servo-mechanisms, with control signals to drive the respective rotations being based on a desired angular position of the instrument (and more specifically of the telescope) and angular measurement signals acquired by sensors of the total station.

Thus, for the azimuthal orientation of the instrument, the aim of the servo-mechanism is to control the absolute angle of the alidade. For this purpose, an optical encoder measures the angular position of the alidade relative to the base. When the instrument is at rest, this measured angular position represents the actual absolute angle, as the absolute angle of the base is constant. In contrast, during movement, the absolute angle of the base may contain high-frequency noise, due to flexibility of the support structure.

An absolute angle of the alidade can also be measured indirectly by measuring its rotational acceleration. Because of sensor bias, this indirect measure will drift over time and is therefore not useful on its own. By combining these two types of measurements, a fused angle signal removing most high frequency dynamics can be obtained, enabling good performance of the feedback loop and control of the instrument under most circumstances.

However, some very unstable support structures may have dynamics that are problematic even when using such a fused angle signal due, for example, to having very large amplitudes and/or having low frequency resonances. There is thus a need for an improved control of such an instrument.

### SUMMARY

In view of the above, an object of the present inventive concept is to provide a control unit for a surveying instrument, a surveying instrument, and a method for controlling such a surveying instrument, that at least alleviates some of the above-mentioned drawbacks.

The invention is defined by the appended independent claims, with embodiments being set forth in the appended dependent claims, in the following description, and in the drawings.

According to a first aspect, there is provided a control unit for a surveying instrument, the surveying instrument comprising a base arranged to be mounted on a support structure and a main body arranged to be rotatable about a first axis in relation to said base. The control unit is configured to:
combine at least a portion of a first angle signal representative of an angular position of said main body relative to said base and a portion of a second angle signal representative of an angular position of said main body relative to an external reference to produce a fused angle signal representative of said angular position of said main body relative to said external reference, and
provide a control signal for rotating said main body about said first axis, wherein said control signal is based on said fused angle signal and a desired angular position of said main body relative to said external reference.

The control unit further comprises a resonance frequency finder configured to estimate at least one resonance frequency associated with said support structure, and a filter component configured to selectively apply at least one filter on said control signal, fused angle signal, or first angle signal, wherein an applied filter is configured to filter out a corresponding respective resonance frequency associated with said support structure estimated by said resonance frequency finder.

According to a second aspect of the present inventive concept, there is provided a surveying instrument comprising:
a control unit according to the first aspect,
a drive component configured to rotate said main body about said first axis based on said control signal,
a first sensor arrangement configured to produce said first angle signal representative of an angular position of said main body relative to said base, and
a second sensor arrangement configured to produce said second angle signal representative of an angular position of said main body relative to an external reference.

According to a third aspect of the present inventive concept, there is provided a method for controlling a surveying instrument, the surveying instrument comprising a base arranged to be mounted on a support structure and a main body arranged to be rotatable about a first axis in relation to the base. The method comprises:
obtaining a first angle signal representative of an angular position of said main body relative to said base,
obtaining a second angle signal representative of an angular position of said main body relative to an external reference,
combining at least portions of said first angle signal and said second angle signal to produce a fused angle signal representative of said angular position of said main body relative to said external reference,
providing a control signal for rotating said main body about said first axis, which control signal is based on said fused angle signal and a desired angular position of said main body relative to said external reference,
estimating at least one resonance frequency associated with said support structure, and
selectively applying at least one filter on said control signal or on said fused angle signal or on said first angle signal, wherein an applied filter is configured to filter out a corresponding respective estimated resonance frequency of associated with said support structure.

The use of a fused angle signal results in good performance of the feedback loop. The present inventive concept is at least partly based on the realization that despite the good performance, the feedback loop may still experience problems under certain specific circumstances that are difficult to predict. This is dependent on the particular setup, including properties of the support structure and its positioning. For example, the length of the legs of a tripod, their angle, their material, thickness, cross-section, whether they are solid or hollow, will influence the dynamics of the system.

In some cases, external influences can excite resonance frequencies in the surveying instrument. Such external influences can be, as non-limiting examples, an operator touching the instrument (for example pushing a button on the instrument), vibrations in the ground from a passing vehicle, a gust of wind, etc.

Because the potentially problematic resonance frequencies are dependent on the setup, i.e. the properties of the support structure and its position, they are difficult to predict. It is also not desirable to broadly filter out many possible resonance frequencies, as this can degrade the performance of the feedback loop.

By the present invention, potentially problematic resonance frequencies, which are associated with the support structure, can be specifically identified and filtered out of the control signal, fused angle signal, or first angle signal. Thereby, the control unit may mitigate the risk of exciting mechanical resonances in the instrument setup. This may ensure a more reliable operation of the surveying instrument.

In the context of this application, the expression “representative of an angular position” in relation to the first angle signal or the second angle signal means that the respective angle signal may not be a direct measurement of an angle and/or may not be directly received by a sensor arrangement. For example, a sensor arrangement may actually measure a motion or acceleration, whereby the angular position can be derived through time integration of the signal. An angle signal produced by a sensor or sensor arrangement may also be subjected to other types of processing, such as filtering, before being further used by the control unit, e.g., before being combined to produce the fused angle signal.

An external reference may for example be an inertial frame of reference.

The control unit may comprise processing circuitry, e.g. at least one processor configured to combine the angle signals, and e.g. a controller for producing the control signal. The resonance frequency finder and/or the filter component may be separate entities or integrated to the at least one processor. Thus, the control unit may be embodied in a single entity or in several separate entities.

The method according to the third aspect may suitably be carried out with a control unit according to the first aspect and/or with an instrument according to the second aspect.

In at least one example embodiment, each applied filter is configured to filter out a corresponding respective estimated resonance frequency associated with said support structure.

The control unit may be configured to apply complementary filters to said first angle signal and said second angle signal to produce said fused angle signal.

Thereby, the fused angle signal may combine the advantages of the first angle signal and second angle signal, while removing bias inherent to the respective angle signals. Such a fused angle signal further allows for a seamless transition, along the frequency band, from the first angle signal to the second angle signal. In other words, the fused angle signal allows a seamless transition from a first type of sensor arrangement to a second type of sensor arrangement.

Alternatively, said first angle signal and said second angle signal may be combined by use of a Kalman filter to produce said fused angle signal.

According to at least one example embodiment, said resonance frequency finder is configured to estimate a predefined number of resonance frequencies associated with said support structure.

Accordingly, the resonance frequency finder may be configured to estimate a number of resonance frequencies corresponding to a likely number of relevant resonance frequencies, depending, for instance, on the type of support structure on which the instrument is mounted. According to an example, said resonance frequency finder may be configured to estimate one, or two, or three resonance frequencies associated with said support structure.

The resonance frequency finder may be configured to estimate said at least one resonance frequency associated with said support structure based on said first angle signal.

According to at least one example embodiment, said first angle signal is subjected to processing before being used by said resonance frequency finder to estimate said at least one resonance frequency, said processing including transforming said first angle signal into an estimated speed signal and/or band pass filtering.

The resonance frequency finder may be configured to estimate resonance frequencies only in a relevant frequency range. A relevant frequency range may, for example, be 20-130 Hz.

The resonance frequency finder may be configured to estimate said at least one resonance frequency associated with said support structure by identifying at least one dominant resonance peak in said first angle signal.

According to at least one example embodiment, the resonance frequency finder is configured to compute a periodogram from the first angle signal. The resonance frequency finder may be configured to use the discrete Fourier transform (DFT). The resonance frequency finder may be configured to use the Fast Fourier Transform (FFT). The at least one dominant resonance peak may be identified using said periodogram.

The resonance frequency finder may be configured to estimate said at least one resonance frequency associated with said support structure by using an adaptive notch filter. This may be more computationally efficient.

According to at least one example embodiment, said at least one filter is implemented as a variable notch filter. The frequency which the at least one filter is configured to filter out may thus be changeable. In embodiments where the resonance frequency finder is configured to estimate said at least one resonance frequency associated with said support structure by using an adaptive notch filter, the variable filter may be a separate filter. In other words, the at least one resonance frequency associated with the support structure is estimated by the adaptive notch filter, while the actual filtering of said control signal, fused angle signal, or first angle signal, is done by the variable notch filter. Thereby, estimation of the at least one resonance frequency and application of the at least one filter may be done independently. The variable notch filter may be active while the adaptive notch filter is inactive, or vice-versa. The variable notch filter and the adaptive notch filter may both be inactive, or they may both be active. In particular, the variable notch filter may be active, i.e., applying a filter to the control signal, fused angle signal, or first angle signal, while the adaptive notch filter is estimating a resonance frequency.

In at least one example embodiment, the at least one resonance frequency is a moving resonance frequency. The control unit may be further configured to track said moving resonance frequency. The at least one filter may be implemented as a variable notch filter configured to filter out said tracked moving resonance frequency.

Small changes in the setup may affect the resonance frequency, i.e., move the resonance frequency up or down. The variable notch filter may thus follow the resonance frequency. As a result, the system may be more reliable even if the setup is changed during operation.

The variable notch filter has a starting frequency upon activation. The filter component may be further configured to deactivate said variable notch filter if a current frequency of said variable notch filter differs from said starting frequency by more than a predetermined drift threshold. The drift threshold may be in the range of 2 to 10 Hz. For example, the drift threshold may be 5 Hz.

The resonance frequency finder may be configured to estimate said at least one resonance frequency when said instrument is at standstill.

If the instrument is moving, the resonance frequency finder may be configured to wait for standstill and some extra relaxation time, before estimating said at least one resonance frequency.

The resonance frequency finder may be configured to estimate said at least one resonance frequency when the power of said control signal exceeds a first threshold, and/or the power of a speed signal based on said first angle signal exceeds a second threshold.

The control signal may, for example, be excited with a pseudorandom binary sequence PRBS, white noise, or similar.

The filter component may be configured to activate said at least one filter if the power of said corresponding respective resonance frequency exceeds a predetermined activation threshold.

Thereby, unnecessary activation of the at least one filter may be avoided, thus avoiding potential degradation of the control loop performance.

The power of a resonance frequency may be estimated by filtering a signal with a band pass filter set to the resonance frequency. The band pass filtered signal is then converted to absolute value and low-pass filtered.

At start-up, said at least one filter may be deactivated. In more detail, irrespective of the number of resonance frequencies estimated by the resonance frequency finder, each respective filter corresponding to a respective resonance frequency may be deactivated at start-up.

The filter component may be configured to deactivate said at least one filter if the power of said corresponding respective resonance frequency is below a predetermined deactivation threshold.

The activation threshold and the deactivation threshold may be different. This may avoid fast switching between activation and deactivation of said at least one filter. In other words, using different activation and deactivation thresholds can introduce a hysteresis, improving control of the filtering.

The resonance frequency finder may be configured to estimate at least two resonance frequencies associated with said support structure, the filter component being configured to selectively apply at least two filters on said control signal, or said fused angle signal, or said first angle signal, wherein each applied filter is configured to filter out a corresponding respective resonance frequency associated with said support structure estimated by said resonance frequency finder.

The filter component may be further configured to pairwise compare the power of said at least two resonance frequencies, and if two filters are closer than a predetermined closeness threshold, deactivate the filter corresponding to the lower power resonance frequency.

The closeness threshold may be in the range of 1 to 10 Hz. For example, the closeness threshold may be 3 Hz.

The support structure may be one of a tripod, a pillar, or a beam.

The first sensor arrangement may comprise at least one optical angle sensor.

The second sensor arrangement may comprise at least one accelerometer and/or inertial measurement unit.

The skilled person recognises that the features and advantages of the present inventive concept presented above apply equally, as far as is compatible, to the control unit according to the first aspect, the instrument according to the second aspect, and the method according to the third aspect. Further features and advantages will become apparent when studying the appended claims and the following description.

### BRIEF DESCRIPTION OF THE DRAWINGS

The inventive concept, some non-limiting embodiments, and further advantages of the inventive concept will now be described with reference to the drawings, in which:

FIG. 1 is a schematic illustration of an instrument according to the present inventive concept,

FIG. 2 is a schematic top view of the instrument of FIG. 1,

FIG. 3 is a schematic illustration of a control loop of the instrument, showing a control unit according to the present inventive concept, and its relation to some components of the instrument, and

FIG. 4 is a flow chart illustrating the general outlines of a method according to the present inventive concept.

### DETAILED DESCRIPTION

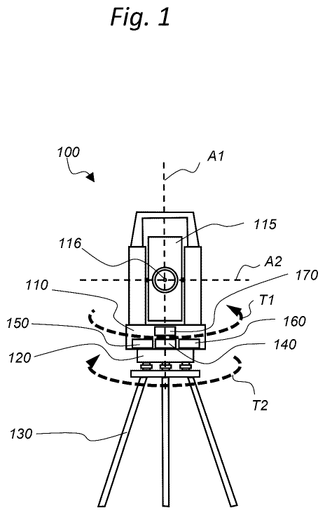

FIG. 1 is a schematic illustration of a surveying instrument 100, in particular a geodetic instrument, according to the present inventive concept. In this example, the instrument is a total station and may alternatively be referred to as a theodolite. The total station 100 comprises a main body, or alidade, 110 rotatably mounted on a base 120. As illustrated, the base 120 may be a tribrach. The base 120 is mounted on a support structure 130, which support structure 130 is here illustrated in the form of a tripod. The base 120 may alternatively be mounted on, for example, a beam, or a pillar. The alidade 110 is rotatable about a first axis A1 by means of a drive unit 140. The drive unit 140 is advantageously a frictionless drive unit, such as an electromagnetic direct drive system.

The total station 100 further comprises a centre unit 115 rotatably mounted on the alidade 110 and rotatable about a second axis A2 intersecting (and preferably orthogonal to) the first axis A1, such that the first axis A1 and second axis A2 intersect within the center unit 115. Thereby, a sighting axis 116 of the total station 100 is rotatable about a rotation point, i.e. the point of intersection of the first axis A1 and the second axis A2. Rotation of the centre unit 115 about the second axis A2 is provided by a drive unit (not illustrated) similar to the drive unit 140. The center unit 115 has an objective, or front lens. The center unit 115 may comprise a plurality of measuring devices, or devices assisting in performing measurements, such as one or more cameras, an electronic distance measurement unit, etc, as well as optical elements, such as splitters, mirrors, lenses and/or filters, for providing optical paths to the devices within the center unit 115.

When in use, the total station 100 is typically set up so that the first axis A1 is plumb.

The total station has a servo mechanism whose aim is to control the orientation or angular position of the alidade 110. Control is provided by the control unit 170.

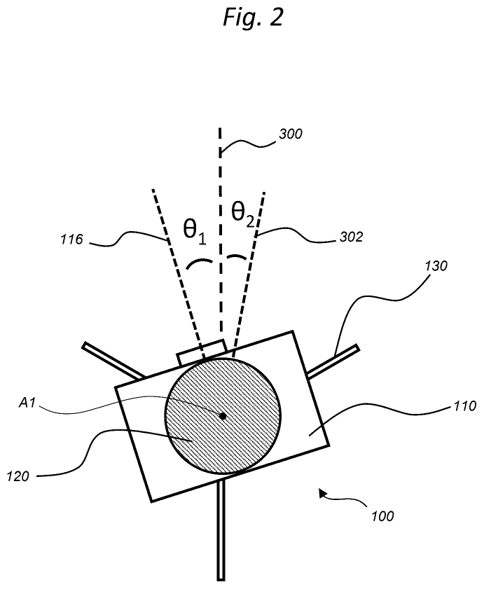

FIG. 2 shows a schematic top view of the total station 100, with the base 120 mounted on the tripod 130 and the alidade 110 mounted on the base 120. The azimuth of the line of sight 116 of the total station can be set by rotating the alidade 110 about the axis A1, i.e., controlling the orientation of the alidade 110. The orientation of the alidade 110 can be defined by the angle θ₁ between the line of sight 116 and an external reference 300, hereafter referred to as the absolute angle θ₁ of the alidade 110. Similarly, the orientation of the base 120 can be defined by the angle θ₂ between a line 302, fixed in relation to the base 120 and intersecting the axis A1, and the external reference 300. Hereafter, this is referred to as the absolute angle θ₂ of the base 120.

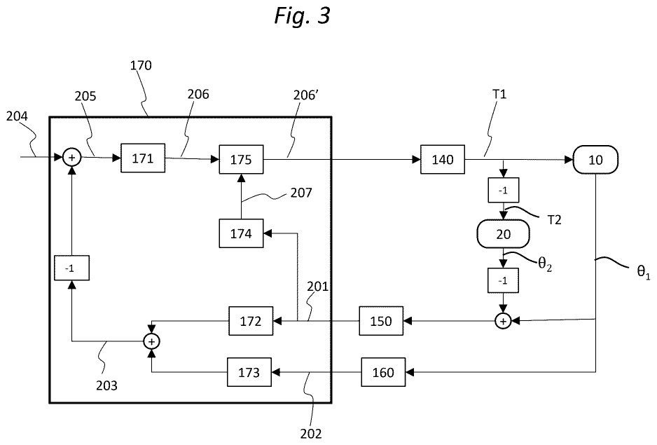

With reference again to FIG. 1, a first sensor arrangement 150, comprising for instance an optical angle sensor, produces a first angle signal (shown at 201 in FIG. 3) representative of the angular position of the alidade 110 relative to the base 120. The first sensor arrangement may alternatively comprise a magnetic or capacitive angle sensor. The first angle signal 201 thus represents the difference between the absolute angles of the alidade 110 and of the base 120, i.e. θ₁-θ₂.

A second sensor arrangement 160, comprising at least one accelerometer, inertial measurement unit, or gyro, produces a second angle signal (shown at 202 in FIG. 3) representative of the angular position of the alidade 110 relative to an external reference. The second sensor arrangement 160 may advantageously comprise two accelerometers arranged in opposite directions on opposite sides of the total station 100. The mean of the signals from these two accelerometers is then free from translational movement, providing a signal representing rotational acceleration only, i.e., a measure of the second derivative θ₁″ of the absolute angle θ₁ of the alidade 110. Integrating the signal a first time provides a measure of the angular velocity of the alidade 110. Integrating the signal a second time thus provides the absolute angle θ1 of the alidade 110.

In response to a control signal (shown at 206, 206′ in FIG. 3), the drive unit 140 applies a torque T1 to rotate the alidade 110 about the first axis A1, thereby changing the absolute angle θ₁ of the alidade 110. A reaction torque T2, being equal and opposite to T1, acts on the base 120 of the total station 100. A tripod may be flexible and becomes more flexible with increasing height and decreased tripod base radius. The tripod typically also has mechanical resonances that depend on the tripod type and leg height. In contrast, a pillar is very rigid and may not introduce significant dynamics. Thus, depending on the flexibility of the tripod 130, the reaction torque T2 may lead to a counter-rotation of the base 120 about axis A1, thereby changing the absolute angle θ₂ of the base 120. In other words, during rotation of the alidade 110, the absolute angle θ₂ of the base 120 will fluctuate.

The fluctuation of θ₂ leads to high-frequency dynamics in the first angle signal 201 representing θ₁-θ₂. The high-frequency dynamics typically includes resonance frequencies. On the other hand, the types of sensors used in the first sensor arrangement 150 are usually not susceptible to low-frequency noise. In contrast, accelerometers are susceptible to low-frequency noise. Accelerometers usually have bias, i.e. they will measure some constant acceleration due to imperfection. Thus, the measured acceleration will drift over time. Accordingly, the second angle signal 202 is accurate in the short term (high-frequency) and the first angle signal 201 is accurate in the long term (low-frequency).

The control unit 170 is configured to combine the first angle signal 201 and the second angle signal 202 to produce a fused angle signal 203, which has much simpler and uniform dynamics compared to the first angle signal 201. When controlling the drive unit 140 using a control signal 206 based on the fused angle signal 203, most resonances are thus eliminated. Depending on the specific setup and on external influences, there is however still a risk that resonance frequencies are excited. This may be mitigated by estimation of resonance frequencies and selective filtering by the control unit 170, as will be further described below.

FIG. 3 is a schematic illustration of the control loop for an embodiment of the instrument illustrated in FIG. 1.

The control unit 170 takes as input the first angle signal 201 provided by the first sensor arrangement 150, the second angle signal 202 provided by the second sensor arrangement 160, and a reference signal 204 representing a desired angular position of the alidade 110. The reference signal 204 may, for example, be manually provided through input in an interface by an operator, or automatically provided by a processor, either of the total station 100 or external to it, for instance for tracking purposes.

The control unit 170 comprises a controller 171. A low-pass filter 172, receiving the first angle signal 201 from the first sensor arrangement 150, and a high-pass filter 173, receiving the second angle signal 202 from the second sensor arrangement 160, are used to produce the fused angle signal 203. The control unit 170 further comprises a resonance frequency finder 174 and a filter component 175.

The first angle signal 201 is subjected to the low-pass filter 172 whereas the second angle signal 202 is subjected to the high-pass filter 173. Filters 172 and 173 are complementary, with the filtered signals being combined into the fused angle signal 203. The choice of crossover frequency between the filters 172 and 173 is a balance between the desire to remove as much high-frequency dynamics as possible on the one hand (leading to a low crossover frequency) and the desire to remove drift and inject less noise from the second sensor arrangement on the other hand (leading to a high crossover frequency).

An error signal 205 representing the difference between the reference signal 204 and the fused angle signal 203 is fed to the controller 171 to produce a control signal 206 for the drive unit 140.

The resonance frequency finder 174 is configured to estimate at least one resonance frequency associated with the support structure 130. A tripod may typically have two or three resonance frequencies in the relevant frequency range. Thus, the frequency finder 174 may, for example, be configured to estimate three resonance frequencies. The resonance frequency finder 174 takes the first angle signal 201 as input. The first angle signal 201 may be subjected to processing before being used to estimate the resonance frequencies. For example, the first angle signal 201 may be differentiated to obtain a speed or velocity signal. This is convenient, as with the speed signal there is no need to keep track of the offset, i.e. in case of a complete rotation around the first axis A1. Additionally, or alternatively, the first angle signal 201 may be bandpass filtered, to ensure that the resonance frequency finder 174 only finds resonance frequencies in a relevant frequency range. For example, the bandpass filter can be set at 20-130 Hz. The processing of the first angle signal 201 described above may be performed within the resonance frequency finder 174. It may alternatively be performed by one or more separate units external to the resonance frequency finder 174.

The actual estimation of a resonance frequency by the resonance frequency finder 174 can be achieved by identifying a dominant resonance peak in the first angle signal 201 (optionally after processing as detailed above). In particular, a dominant peak may be identified from a periodogram computed e.g. using the discrete Fourier transform (DFT) or the fast Fourier transform (FFT).

A resonance frequency may also be estimated by using an adaptive notch filter. Adaptive notch filters have a parameterized blocking frequency and can recursively search for the correct frequency. Further details of the implementation of such an adaptive notch filter will be familiar to the person skilled in the art. Several adaptive notch filters may be used. For example, if the resonance frequency finder 174 is configured to estimate three resonance frequencies, three separate adaptive notch filters may be used. An adaptive notch filter is also useful for tracking a moving resonance frequency.

Thus, the resonance frequency finder 174 estimates a resonance frequency. The estimated resonance frequency 207 is then provided to the filter component 175. The filter component operates as a variable notch filter, and selectively applies to the control signal 206 a filter configured to remove the estimated resonance frequency 207. This results in a filtered control signal 206′, which the control unit 170 provides to the drive unit 140. As a notch filter, particularly a low-frequency notch filter, may affect the performance of the feedback loop, the notch filter should preferably be as narrow in the stopband as possible, which may be in conflict with the desire to block a resonance that could have a wider frequency span. For higher frequencies, there is more margin before affecting the closed loop control system, so the notch filter may be quite wide.

As described in connection to FIG. 1, the drive unit 140 applies a torque T1 to the alidade 110, producing a rotation 10 of the alidade 110. An equal and opposite reaction torque T2 acts on the base 120, producing a rotation 20 of the base 120. The rotations 10, 20 of the alidade 110 and base 120 result in the absolute angle θ₁ of the alidade, and the absolute angle θ₂ of the base, respectively. The first sensor arrangement 150 measures the difference θ₁-θ₂, whereas the second sensor arrangement 160, measures the angular acceleration θ₁″, as detailed above.

As described above, the present inventive concept thus enables a resonance frequency (or multiple resonance frequencies) to be continuously, or repeatedly, estimated during operation of the total station. The estimated resonance frequency is then removed from the control loop, thus minimizing the risk of exciting the resonance frequency. This leads to improved mechanical stability of the total station.

In alternative embodiments of the control unit 170, the filter component 175 is configured to apply a filter removing estimated resonance frequency 207 on the fused angle signal 203, or on the first angle signal 201, respectively, instead of on the control signal 206 as illustrated in FIG. 3.

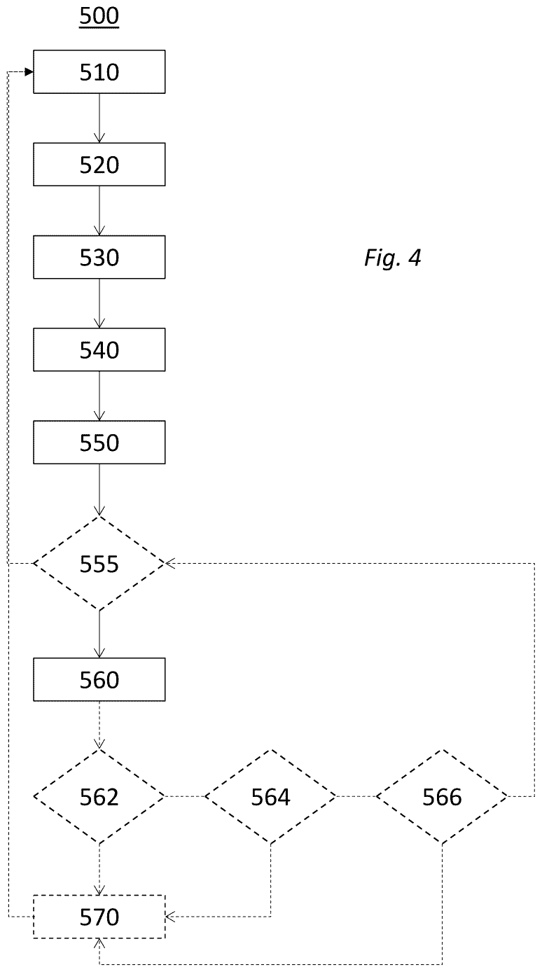

The flow chart in FIG. 4 illustrates a method 500 according to the present inventive concept. The method may be performed by a total station 100 as illustrated in FIG. 1 and/or by a control unit 170 as illustrated in FIG. 3.

At 510, a first angle signal 201 representative of an angular position of the alidade 110 relative to the base 120 of the total station 100 is obtained.

At 520, a second angle signal 202 representative of an angular position of the alidade 110 relative to an external reference is obtained.

At 530, portions of the first angle signal 201 and of the second angle signal 202 are combined to produce a fused angle signal 203 representative of the angular position of the alidade relative the external reference.

At 540, a control signal for rotating the alidade about the first axis A1, based on the fused angle signal 203 and a reference signal 204 representing a desired angular position of the alidade 110, is provided.

At 550, at least one resonance frequency associated with the support structure is estimated.

At 555, the power of the estimated resonance frequency is optionally checked against an activation threshold. If the power of the estimated resonance frequency exceeds the activation threshold, the method continues at 560. If the power of the estimated resonance frequency is below the activation threshold, the method returns to step 510.

At 560, a filter is applied on the control signal, the fused angle signal, or the first angle signal, which filter is configured to filter out the estimated resonance frequency obtained in step 550.

The remaining steps are optional.

At 562, the power of the estimated resonance frequency may be checked against a deactivation threshold. If the power of the estimated resonance frequency exceeds the deactivation threshold, the filter is deactivated at 570.

If the power of the estimated resonance frequency is below the deactivation threshold, the method continues at 564.

At 564, the filter may be checked against a drift threshold. The filter may be a variable notch filter, in which case, the current frequency of the variable notch filter is compared to its starting frequency. If the current frequency differs from the starting frequency by more than the drift threshold, the filter is deactivated at 570; otherwise, the method continues at 566.

Several filters may be active at the same time. At 566, the power of the filters may be pairwise compared. If two filters are closer, in the frequency band, than a closeness threshold, the filter having the lowest power (of the two) is deactivated at 570. If the filters are farther from each other than the closeness threshold, the method continues at 555.

After deactivation of a filter at 570, the method continues at 510.

It will be appreciated by the skilled person that the optional steps 562, 564, 566 may be performed in a different order to the same effect. It will also be appreciated that the steps of the method can also be performed concurrently. In other words, the method is continuously performed.

The person skilled in the art realises that the present inventive concept by no means is limited to the preferred embodiments described above. On the contrary, many modifications and variations are possible within the scope of the appended claims. The word “comprising” does not exclude the presence of other elements or steps than those listed in the claims. The word “a” or “an” preceding an element does not exclude the presence of a plurality of such elements. Additional, variations to the disclosed embodiments can be understood and effected by the skilled person in practicing the claimed invention, from a study of the drawings, the disclosure, and the appended claims.

1. A control unit for a surveying instrument, the surveying instrument comprising a base arranged to be mounted on a support structure and a main body arranged to be rotatable about a first axis in relation to said base,
said control unit being configured to:
combine at least a portion of a first angle signal representative of an angular position of said main body relative to said base and a portion of a second angle signal representative of an angular position of said main body relative to an external reference to produce a fused angle signal representative of said angular position of said main body relative to said external reference,
provide a control signal for rotating said main body about said first axis, wherein said control signal is based on said fused angle signal and a desired angular position of said main body relative to said external reference,
wherein said control unit further comprises:
a resonance frequency finder configured to estimate at least one resonance frequency associated with said support structure, and
a filter component configured to selectively apply at least one filter on said control signal, said fused angle signal, or said first angle signal, wherein an applied filter is configured to filter out a corresponding respective resonance frequency associated with said support structure estimated by said resonance frequency finder.

2. The control unit according to claim 1, wherein said control unit is configured to apply complementary filters to said first angle signal and said second angle signal to produce said fused angle signal.

3. The control unit according to claim 1, wherein said resonance frequency finder is configured to estimate a predefined number of resonance frequencies associated with said support structure.

4. The control unit according to claim 1, wherein said resonance frequency finder is configured to estimate said at least one resonance frequency associated with said support structure based on said first angle signal.

5. The control unit according to claim 4, wherein said first angle signal is subjected to processing before being used by said resonance frequency finder to estimate said at least one resonance frequency, said processing including transforming said first angle signal into an estimated speed signal and/or bandpass filtering.

6. The control unit according to claim 4, wherein said resonance frequency finder is configured to estimate said at least one resonance frequency associated with said support structure by identifying at least one dominant resonance peak in said first angle signal.

7. The control unit according to claim 4, wherein said resonance frequency finder is configured to estimate said at least one resonance frequency associated with said support structure by using an adaptive notch filter.

8. The control unit according to claim 1, wherein said at least one filter is implemented as a variable notch filter.

9. The control unit according to claim 1, wherein said at least one resonance frequency is a moving resonance frequency, said control unit is further configured to track said moving resonance frequency, and said at least one filter is implemented as a variable notch filter configured to filter out said tracked moving resonance frequency.

10. The control unit according to claim 9, wherein said variable notch filter has a starting frequency upon activation, and said filter component is further configured to deactivate said variable notch filter if a current frequency of said variable notch filter differs from said starting frequency by more than a predetermined drift threshold.

11. The control unit according to claim 1, wherein said resonance frequency finder is configured to estimate said at least one resonance frequency when said instrument is at standstill.

12. The control unit according to claim 1, wherein said resonance frequency finder is configured to estimate said at least one resonance frequency when:
the power of said control signal exceeds a first threshold, and
the power of a speed signal based on said first angle signal exceeds a second threshold.

13. The control unit according to claim 1, wherein said filter component is configured to activate said at least one filter if the power of said corresponding respective resonance frequency exceeds a predetermined activation threshold.

14. The control unit according to claim 1, wherein said filter component is further configured to deactivate said at least one filter if the power of said corresponding respective resonance frequency is below a predetermined deactivation threshold.

15. The control unit according to claim 1, wherein
said resonance frequency finder is configured to estimate at least two resonance frequencies associated with said support structure,
said filter component is configured to selectively apply at least two filters on said control signal, said fused angle signal, or said first angle signal, wherein each applied filter is configured to filter out a corresponding respective resonance frequency associated with said support structure estimated by said resonance frequency finder,
and wherein said filter component is further configured to pairwise compare the power of said at least two resonance frequencies, and if two filters are closer than a predetermined closeness threshold, deactivate the filter corresponding to the lower power resonance frequency.

16. A surveying instrument comprising:
a control unit according to claim 1,
a drive component configured to rotate said main body about said first axis based on said control signal,
a first sensor arrangement configured to produce said first angle signal representative of an angular position of said main body relative to said base, and
a second sensor arrangement configured to produce said second angle signal representative of an angular position of said main body relative to an external reference.

17. The instrument according to claim 16, wherein said support structure is one of a tripod, a pillar, or a beam.

18. The instrument according to claim 16, wherein said first sensor arrangement comprises at least one optical angle sensor.

19. The instrument according to claim 16, wherein said second sensor arrangement comprises at least one accelerometer and/or inertial measurement unit.

20. A method for controlling a surveying instrument, the surveying instrument comprising a base arranged to be mounted on a support structure and a main body arranged to be rotatable about a first axis in relation to said base, the method comprising:
obtaining a first angle signal representative of an angular position of said main body relative to said base,
obtaining a second angle signal representative of an angular position of said main body relative to an external reference,
combining at least portions of said first angle signal and said second angle signal to produce a fused angle signal representative of said angular position of said main body relative to said external reference,
providing a control signal for rotating said main body about said first axis, which control signal is based on said fused angle signal and a desired angular position of said main body relative to said external reference,
estimating at least one resonance frequency associated with said support structure, and
selectively applying at least one filter on said control signal, said fused angle signal, or said first angle signal, wherein each applied filter is configured to filter out a corresponding respective estimated resonance frequency associated with said support structure.
